(19) United States
(12) Patent Application Publication
(10) Pub. No.: US 2020/0180959 A1
(43) Pub. Date: Jun. 11, 2020

(54) PROCESS FOR PRODUCING NITRIC ACID

(71) Applicants: YARA INTERNATIONAL ASA, Oslo (NO); THE UNIVERSITY OF SYDNEY, Sydney (AU)

(72) Inventors: Brian Scott Haynes, Frenchs Forest (AU); Anthony Matthew Johnson, Double Bay (AU)

(21) Appl. No.: 16/636,111

(22) PCT Filed: Aug. 24, 2018
(86) PCT No.: PCT/AU2018/050908

§ 371 Date: Feb. 3, 2020

(30) Foreign Application Priority Data
Aug. 4, 2017 (AU) 2017903409

(51) Int. Cl. C01B 21/46

(52) U.S. Cl. CPC C01B 21/46; C01B 2210/0004; C01B 2210/0075

(57) ABSTRACT

A process is disclosed for removing nitrous components from a raw liquid nitric acid stream to produce a bleached nitric acid product (55). The raw liquid nitric acid stream (37) is from an absorber (19) of a nitric acid process. The process comprises contacting the raw nitric acid liquid stream with an oxidising gas (12) in a bleaching stage (52). At least some of the gas effluent (12c) from the bleaching stage enters (12d) a combustion stage (15) of the nitric acid process. The oxidising gas (12) entering the bleaching stage (52) may comprise at least about one-third of an oxidising gas feed (12) to the nitric acid process. At least about one-tenth of the bleaching stage gas effluent (12c) may enter (12d) the combustion stage (15).

### TECHNICAL FIELD

A process is disclosed for the production of nitric acid. More specifically, a process is disclosed for the production of nitric acid that gives rise to very low levels of nitrous components in the nitric acid product, and to negligible gaseous emissions of NOx.

### BACKGROUND ART

U.S. Pat. No. 9,199,849 discloses a process for producing nitric acid in which a gaseous oxidizer feed composed substantially of ammonia, steam and an oxidizing gas is exposed to conditions whereby the ammonia is oxidized to produce a reaction mixture including nitrogen monoxide and water vapour. The reaction mixture is then cooled in a heat exchanger whereby: a) the nitrogen monoxide is oxidized and the water vapour is caused to condense, b) the products of the nitrogen monoxide oxidation react with and are absorbed by the condensed water, and c) substantially all of the nitrogen monoxide in the reaction mixture is converted to nitric acid.

The nitric acid produced by the process of U.S. Pat. No. 9,199,849 is inherently dilute, having for example a concentration of the order of 20% to 40% HNO₃ (w/w), depending upon the amount of water that is contained in the reaction mixture. Whilst the dilute nitric acid produced by the process of U.S. Pat. No. 9,199,849 does not require bleaching in order to remove colour from the acid product, it has been discovered that the nitrous acid level in the dilute nitric acid may, nevertheless, be excessively high for some purposes. For example, if the nitric acid is to be employed for the manufacture of ammonium nitrate, nitrous acid present therein may give rise to the formation of ammonium nitrite, which is unstable and, therefore, a potential cause of unintended explosion. In these circumstances, removal of the dissolved nitrous acid and other nitrous components from the product acid, for example by means of gas stripping in a bleacher, may be beneficial, even in the absence of colour.

U.S. Pat. No. 4,081,517 discloses a process for removing nitrogen oxides from a fluid stream and converting them to nitric acid. The fluid stream arises from an ammonia oxidation process. The process of U.S. Pat. No. 4,081,517 includes the steps of: (a) further oxidizing a portion of the nitrogen oxides carried in the fluid stream; (b) removing liquid and gaseous effluents from the oxidizing step; (c) scrubbing the gaseous effluent removed from the oxidizing step with an aqueous solution of nitric acid; (d) separating the liquid and gaseous components of the stream removed from the scrubbing step; (e) bleaching the oxidizing and scrubbing liquid streams in contact with a countercurrent flow of gas; (f) passing the gas stream emitted from bleaching step to the oxidizing step; and (g) withdrawing product nitric acid from the bleaching step.

In the foregoing, “nitrous acid” refers specifically to the component HONO (or HNO₂) which, with a nitrogen oxidation state of +3, is under-oxidised relative to nitric (HNO₃) product, in which the oxidation state of nitrogen is +5.

The above references to the background art do not constitute an admission that the art forms a part of the common general knowledge of a person of ordinary skill in the art. The above references are also not intended to limit the application of the process as disclosed herein.

### SUMMARY OF THE DISCLOSURE

Disclosed herein is a process for removing nitrous components from a raw liquid nitric acid stream to produce a bleached nitric acid product. The raw liquid nitric acid stream is from an absorber of a nitric acid process. The process comprises contacting the raw nitric acid liquid stream with an oxidising gas in a bleaching stage. In the process at least some of the gas effluent from the bleaching stage enters a combustion stage of the nitric acid process.

Passing at least some of the oxidising gas through the bleaching stage prior to its entering the combustion stage can enable larger oxidising gas flows through a bleacher of the bleaching stage to be achieved, than when the gas effluent from the bleaching stage completely bypasses the combustion stage. In turn, this can enable the size of the bleacher and/or operating temperature of the bleaching stage to be minimised.

The process as disclosed herein can, for example, provide an improvement to the process described in U.S. Pat. No. 9,199,849. In this regard, nitrous components can be removed from the nitric acid liquid effluent from the absorber by physically contacting the oxidising gas feed stream with the nitric acid liquid effluent stream in the bleaching stage.

Further, the process as disclosed herein, in contrast to the process described in U.S. Pat. No. 4,081,517, comprises a step in which at least some of the gas effluent from the bleaching stage enters a combustion stage of the nitric acid process. Whereas, in U.S. Pat. No. 4,081,517 the fluid stream that is fed to the process is a stream that is the product of (i.e. has already been removed from) the ammonia combustion process.

In one embodiment, this contact may be undertaken at a volumetric flow rate of gas which is adequate to remove most of the nitrous acid (e.g. to levels below 100 milligrams of nitrous acid per kilogram of nitric acid bleacher liquid effluent). A minimum gas volumetric flow rate can be a function of, amongst other things, the liquid volumetric flow rate, the operating temperature of the bleacher, and bleaching stage (i.e. bleacher) volume.

In one embodiment, the oxidising gas entering the bleaching stage may comprise at least about one-third of an oxidising gas feed to the nitric acid process. In this embodiment, at least about one-tenth of the bleaching stage gas effluent may enter the combustion stage. When at least one-third of the oxidising gas feed is employed for the acid bleaching process, at least one-tenth of the gas effluent from the bleaching stage is directed to the feed to the combustion stage in order for the combustion stage to receive a required oxidising gas flow rate for complete oxidation of ammonia. This stands in contrast to conventional practice in prior art processes wherein the bleaching gas (air) is secondary air (which does not enter the combustion stage) only.

In one embodiment, at least 90% of the oxidising gas feed to the nitric acid process may enter the bleaching stage. In this embodiment, at least 65% of the bleaching stage gas effluent may enter the combustion stage. More typically, at least 67% of the bleaching stage gas effluent may enter the combustion stage.

For example, where 100% of the oxidising gas feed enters the bleaching stage, the process may be considered to be the least complex in that:
no splitting of the oxidising gas feed is required (which may otherwise incur piping and, potentially, control costs);
a fixed size bleaching stage may be operated at the lowest possible temperature in order to achieve a required residual nitrous acid level. Alternatively, a bleaching stage operating at a fixed temperature may be of minimum size in order to achieve a required residual nitrous acid level.

In one embodiment, the fraction of the bleaching stage gas effluent which enters the combustion stage may be at least:

$$1 - \frac{c - 0.3}{B} , \\ B + C \leq 1$$

where B is the fraction of the oxidising gas feed to the nitric acid process which enters the bleaching stage, and C is a fraction of the oxidising gas feed which bypasses both the bleaching and combustion stages.

In one embodiment, a ratio of the volumetric feed rate of oxidising gas to the bleaching stage to the volumetric flow rate of raw nitric acid to the bleaching stage may be no less than:

$$2.4 \times {10}^{- 10} \cdot {e}^{\frac{8730}{{T}_{b}}}$$

where T_{b} is the average absolute temperature in degrees Kelvin of liquid within the bleaching stage.

In another embodiment, a ratio of the volumetric feed rate of oxidising gas to the bleaching stage to the volumetric flow rate of raw nitric acid to the bleaching stage may be no less than:

$$2.4 \times {10}^{- 10} \cdot {{e}^{\frac{8730}{{T}_{b}}} ( \frac{Hbl}{0.1} )}^{- 0.67}$$

where T_{b} is the average absolute temperature in degrees Kelvin of liquid within the bleaching stage, and where Hbl is the ratio of the bleacher volume to the volumetric flow rate of nitric acid product produced by the process (i.e. the nitric acid product leaving the process).

The term “oxidising gas” as referred to above and as employed herein can refer to a gas comprising about 80% (v/v) oxygen, or more than about 80% (v/v) oxygen. For example, the oxidising gas may comprise at least 90% (v/v) and, depending upon plant size, may comprise at least 95% (v/v) oxygen.

The term “nitrous components” as referred to above and as employed herein should be understood to refer collectively to any combination of nitrous acid with nitrogen oxides in which the oxidation state of nitrogen is from +2 to +4 inclusive (NO, NO₂, N₂O₃, and N₂O₄).

The following TABLE 1 lists the nitrous components, noting their oxidation state and the stoichiometric number of ozone molecules required to produce a nitrogen oxidation state of +5 (N₂O₅ or HNO₃) from each of them, assuming each molecule of ozone donates one oxygen atom towards the oxidation of the nitrous components.

TABLE 1
Oxidation state of nitrogen in various nitrous components, and
molecules of ozone per molecule to reach nitrogen oxidation state +5.

| Oxidised nitrogen | Nitrogen oxidation | Ozone molecules required |
|---|---|---|
| components | state | for oxidation state +5 |
| NO | +2 | 1.5 |
| N₂O₃ | +3 | 2 |
| HNO₂ | +3 | 1 |
| NO₂ | +4 | 0.5 |
| N₂O₄ | +4 | 1 |

It should be noted that, whilst the bleaching of nitric acid by a secondary air stream in order to remove nitrous components is a normal part of a conventional production process for concentrated nitric acid (50% to 68% w/w), the present inventors have found that traditional operating conditions for bleaching concentrated acid are unexpectedly unsuccessful when applied to dilute nitric acid such as from the process of U.S. Pat. No. 9,199,849.

In particular, the present inventors have found through investigation that the predominant mechanism for nitrous acid removal in bleaching of concentrated nitric acid solutions is the reaction of nitric acid with nitrous acid to produce NO₂. Such investigations have also shown that this mechanism is far less active in the bleaching of dilute nitric acid, and alternative mechanisms must be promoted. As a result, and contrary to the expectations of those skilled in the art, when dilute nitric acid is fed to the bleaching stage, this stage is operated:
with a gas-to-liquid flow volume ratio higher than typically required in conventional bleachers.
at a temperature which is higher than typically required in conventional bleachers, with the minimum temperature required being a function of the gas volumetric flow.

In one embodiment, the process may further comprise a scrubbing stage in which bleached nitric acid from the bleaching stage may be contacted with gas phase effluent from the absorber. The present inventors have identified that, for example, bleached dilute nitric acid can be a suitable agent for scrubbing most of the nitrous components from the gas phase of the effluent from the absorber (e.g. heat exchange absorber) of the nitric acid process. This can produce a tail gas that requires minimal further processing to be suitable for atmospheric discharge, and can avoid the loss of the scrubbed components from the process.

In one embodiment, the flow of the bleached nitric acid from the bleaching stage to the scrubbing stage may at least be about 25% of nitric acid product produced by the process (i.e. of the nitric acid product leaving the process). Such a flow can remove most of the nitrous components from a gas phase effluent (tail gas) of the scrubbing stage. A reduction of nitrous components by at least one order of magnitude may be achieved, e.g. to a level of less than 0.5 mol % (dry basis).

In one embodiment, the temperature of liquid feeds to the bleaching and scrubbing stages may be approximately 50° C. (±7° C.). In this embodiment, the flow of bleached nitric acid to the scrubbing stage may be approximately 50% (+50%, −25%), of nitric acid product produced by the process (i.e. of the nitric acid product leaving the process).

In another embodiment, the temperature of liquid feeds to the bleaching and scrubbing stages may be approximately 51° C. (±4° C.). In this embodiment, the flow of bleached nitric acid to the scrubbing stage may be approximately 50% (+30%, −20%), of nitric acid product produced by the process (i.e. of the nitric acid product leaving the process).

In one embodiment, the scrubbing stage may further comprise oxidising substantially all the nitrous components in a gas phase effluent of the scrubbing stage to a nitrogen oxidation state of +5. In this regard, the nitrous components in the scrubbing stage gas phase effluent (tail gas) may be oxidised with a strong oxidant, such as ozone or hydrogen peroxide.

For example, such residual nitrous components in the scrubbing stage gas phase effluent (tail gas) may be eliminated through reaction with a small flow of ozone in an ozonator. This can produce further nitric acid product and, at the same time, can render the tail gas essentially free of nitrous components. In the ozonator, nitrous components can be oxidised to N(+5) by stoichiometric reaction with ozone, whereby each ozone (O₃) molecule donates one oxygen atom. The stoichiometric ozone requirements for such oxidation of the individual nitrous components are shown in TABLE 1 (above).

In one embodiment, the molar flow rate of ozone may be ≤0.4% of the molar flow rate of a nitric component in the bleached nitric acid produced by the bleaching stage. More specifically, the molar flow rate of ozone may be ≤0.2% of the molar flow rate of the nitric component in the bleached nitric acid produced by the bleaching stage.

In one embodiment, the ozone may be a component in an oxygen-rich stream comprising ≤2% of the molar flow rate of the oxidising gas feed to the nitric acid process. More specifically, the ozone may be a component in an oxygen-rich stream comprising ≤1% of the molar flow rate of the oxidising gas feed to the nitric acid process.

In a further embodiment, residual ozone in the tail gas effluent from the ozonator may be destroyed by a suitable ozone decomposition catalyst, such as manganese oxide. The catalyst may be housed in, or adjacent to, a demister.

It should be noted that any nitrous components which leave the process in the tail gas, or as nitrous acid in the nitric acid liquid, represent a loss to the process efficiency. By capturing nitrous components in the bleacher, scrubber and ozonator, losses of about 5% can be avoided.

In one embodiment, the nitric acid produced by the nitric acid process comprises dilute nitric acid. For example, the dilute nitric acid has a concentration of approximately 20% to 40% HNO₃ (w/w).

### BRIEF DESCRIPTION OF THE DRAWINGS

Notwithstanding any other forms which may fall within the scope of the process as defined in the Summary, specific embodiments will now be described, by way of example only, with reference to the accompanying drawings in which:

FIG. 1 shows a flow diagram applicable to an embodiment of the process as disclosed herein in which:
A. steam, ammonia and an oxidising gas are combined to form a combustor feed for the production of nitric acid,
B. raw nitric acid is formed within a heat exchanger absorber,
C. nitrous acid is removed from the raw nitric acid stream in a bleacher through contact with the oxidising gas, and
D. nitrous components are removed from the tail gas in a scrubber, through contact with bleached nitric acid.

FIG. 2 shows an embodiment of the process in which an ozonator further diminishes the concentration of nitrous components in the tail gas.

FIG. 3 relates to the bleacher, and charts the dependence of the minimum required gas volumetric flow on temperature, for (a) equilibrium stripping only, meaning vapour/liquid equilibrium without chemical reaction and (b) equilibrium stripping and chemical reaction, in reducing the liquid effluent nitrous acid concentration to acceptable levels.

FIG. 4 again relates to the bleacher, charting the maximum available gas volumetric flows together with the minimum required gas volumetric flow, for both (a) concentrated acid and (b), (c) dilute nitric acid.

FIG. 5 again relates to the bleacher, charting the effect of bleacher volume on the minimum required gas volumetric flow for dilute acid only.

FIG. 6 refers to the scrubber, charting the temperature dependence of (a) the required scrubber volume and (b) the required scrubber bleached acid flow, in reducing nitrous components in the gas effluent to satisfactory levels.

FIG. 7 charts the total volume required for the bleacher and scrubber as a function of (a) the common operating temperature and (b) the bleached acid flow rate to the scrubber.

### DETAILED DESCRIPTION OF SPECIFIC EMBODIMENTS

In the following detailed description, reference is made to the accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Nitric Process

In the process illustrated in FIG. 1, a gaseous ammonia feed stream 10, a steam feed stream 11 and an oxidising gas stream 12d are combined to form a combustor feed 13. All feed streams are delivered under a pressure slightly greater than a combustion pressure which is above atmospheric pressure and typically of about 2 bar (abs.).

The combustor 15 may incorporate a platinum-rhodium catalyst in the form of woven or knitted gauze layers. The combustor feed 13 (comprising a steam-ballasted ammonia-oxidising gas mixture) is heated by a combination of conduction, convection and radiation to the reaction temperature by the catalyst layers and reacts on the catalyst layers to form a nitrous gas stream 16. The overall process is essentially adiabatic and the temperature reached is primarily a function of the quantity of steam ballast present. When the oxidising gas 12d is present in quantities in excess of ammonia combustion requirements, it also acts as a thermal ballast. The temperature will typically be about 800° C. when the molar ratio of water to ammonia in the combustor feed is about 5.6 and the concentration of ammonia in the combustor feed is about 11.4% (v/v). Such a combustor feed composition lies outside the expected ammonia explosion limits and gives rise to nitric acid product concentration of about 33.5% HNO₃ (w/w).

The resultant nitrous gas 16, including nitrogen monoxide and water vapour, is fed to a following cooler 17 where the nitrous gas is cooled by heat exchange with a heat transfer fluid to a temperature (of the order of 140° C.) above the level of dew point of the nitrous gas.

On exiting from the cooler the cooled nitrous gas stream 18, in which nitrogen monoxide will have started to oxidise, is fed to an absorber 19 in the form of a heat exchanger. Water vapour condensation and continuing oxidation of the nitrogen monoxide and concurrent reactions leading to the formation of nitric acid, in passages 20 in the absorber, are governed by the operating pressures and temperatures employed in the system. Heat is exchanged between the cooled reaction mixture and heat exchange fluid, typically water, that is directed counter-current though channels 21 of the absorber. Fluid flow passages 20 and 21 within the absorber typically have a small cross-sectional dimension (typically less than about 3 mm and, typically, less than 2 mm equivalent diameter) in order to assist heat and mass transfer and, thus, plant compactness.

Gases not condensed or absorbed in the absorber are carried in the two-phase absorber effluent stream 23, and are separated from the raw nitric acid stream 37 by a separator 31.

The heat exchanger absorber 19 referred to in the preceding paragraph can be inherently compact in comparison with conventional concentrated acid absorbers because the use of an oxygen-rich oxidising gas rather than air greatly reduces gas phase mass transfer resistances and increases gas phase component concentrations, thus promoting rapid gas phase reaction. The heat exchanger absorber may be less than one-tenth the volume of a conventional absorber for similar acid production rates, and the use of a compact heat exchanger construction (such as a Printed Circuit Heat Exchanger) may produce further size reductions. This invention addresses the removal of nitrous components from the gas and liquid phases of the absorber effluent in equipment which is proportionate in size to the compact absorber.

Bleacher

The raw nitric acid liquid stream 37 from the separator is pumped by pump 38 to a pressure above the combustor pressure and then subjected to counter-flow contact with part or all of the oxidising gas feed 12 in a bleacher 52, in order to remove nitrous components, and especially nitrous acid, from the raw nitric acid. The bleacher may take the form of a packed tower, for example employing random or structured packing, or may employ stage-wise contacting in trays, such as sieve trays or valve trays. As illustrated in FIG. 1, the vessel 50 housing the bleacher 52 may also house a separator 51 and a demister 53.

On leaving the absorber 19, the raw nitric acid liquid stream 37 may contain nitrous acid at levels greater than 1,000 milligrams of nitrous acid per kilogram of dilute nitric acid (mg/kg), and may approach 10,000 mg/kg. Within the bleacher 52, nitrous acid is typically removed to a level below 100 mg/kg, which is considered to be consistent with the safe levels of ammonium nitrite in ammonium nitrate derived from the bleached nitric acid product 55. To provide a margin of safety, more typically the nitrous acid is reduced to below 10 mg/kg.

Some of the oxidising gas feed 12 may bypass the bleacher 52, and be directed to the combustor as 12e, to the hot nitrous gas stream 16 as 12h, and/or to the cooled nitrous gas stream 18 as 12g. However, in order to minimise the size and/or the operating temperature of the bleacher 52, at least 20% of the oxidising gas feed 12 should pass through the bleacher 52 in stream 12a. Typically the proportion of oxidising gas feed passing through the bleacher 52 exceeds 50%, more typically exceeding 90%, and most typically exceeding 98%. Where 100% of the oxidising gas feed passes through the bleacher 52, implementation of the process is least complex in that:
no splitting of the oxidising gas feed 12 is required, which would incur piping and, perhaps, control costs;
the bleacher 52 of a fixed size may operate at the lowest possible temperature in order to achieve a required residual nitrous acid level (as discussed below) thereby potentially avoiding capital and operating costs for a heater 39 for the liquid feed 37 to the bleacher 52 and a cooler 57 for the liquid recycle 56 to a scrubber 32 forming part of a scrubber vessel 30.

The raw nitric acid 37 may require heating prior to, or during, the contact within the bleacher 52 in order to enable a suitable degree of nitrous acid removal to be achieved within a bleacher 52 of reasonable size. For example, heater 39 may pre-heat the raw nitric acid. Alternatively, vessel 50 may incorporate heating means (not shown). Heating is most likely to be required when the proportion of the oxidising gas feed passing through the bleacher 52 is relatively low.

The bleacher 52 in the depicted embodiment is a counterflow device in which the gas effluent 12c at the top of the bleacher 52 contacts the incoming raw nitric acid stream 37. It follows from physical principles that the nitrous acid partial pressure in the gas effluent is less than or equal to the saturation pressure of the nitrous acid in the raw nitric acid feed.

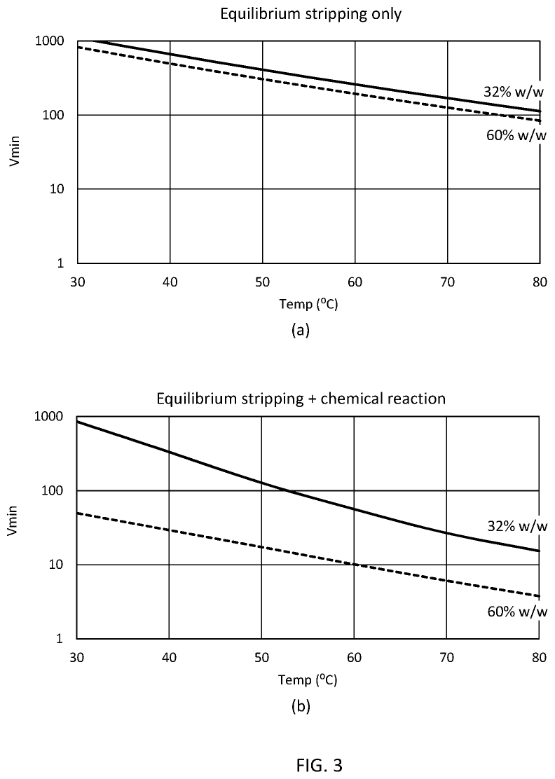

An upper bound on the minimum required volumetric flow ratio (Vmin) between the oxidising gas feed 12a and the raw nitric acid feed 37a to bleacher 52 can be determined as follows. (The Vmin is the minimum flow ratio at which the required nitrous acid removal is physically possible, in the light of considerations in the preceding paragraph.) If bleacher 52 was considered to be a physical stripper only, without internal chemical reaction and with physical equilibrium between the raw nitric acid feed and the gas effluent, all of the removed nitrous acid in the raw nitric acid would need to leave the bleacher with the gas effluent. Vmin for such a situation can be calculated, using published thermodynamic theory and data for nitrous acid, as a function of nitric acid strength and temperature, as shown in FIG. 3a for the temperature range 30° C. to 80° C. and for less than 100 milligrams of nitrous acid residue per kilogram of nitric acid (mg/kg). This relationship is essentially independent of the nitrous acid content of the raw nitric acid feed, as higher nitrous acid content in the liquid feed sustains higher vapour pressure, and hence higher nitrous acid content in the gas effluent.

In practical bleachers the Vmin shown in FIG. 3a is modified due to chemical reactions within the bleacher 52. The chemical reactions supplement the physical stripping mechanism by destroying nitrous acid, thereby reducing the nitrous acid partial pressure of the gas effluent for a given amount of nitrous acid removal from the raw nitric acid. Bleachers of practical and finite size are also subject to finite mass transfer resistances which impede the approach of the physical stripping process to equilibrium and also constrain the extent of kinetically limited chemical reactions.

With regard to the chemical reactions, nitrous acid may be destroyed through the reaction between nitrous acid (HONO) and nitric components (HNO₃, NO₃⁻+H₃O⁺ in solution) according to Eqn. 1 in the liquid phase and Eqn. 2 in the gas phase, or through disproportionation, primarily in the liquid phase, according to Eqn. 3.

HONO+NO₃⁻+H₃O⁺ [symbol] 2 NO₂+2 H₂O Eqn. 1

HONO+HNO₃ [symbol] 2 NO₂+H₂O Eqn. 2

2 HONO [symbol] NO+NO₂+H₂O Eqn. 3

Oxidation of nitrous acid, either directly or through intermediates such as NO, plays little role in nitrous acid removal in a bleacher.

The inventors have investigated the operative chemical reaction equilibria and kinetics in both conventional concentrated nitric acid bleachers (approximately 60% w/w with inlet nitrous acid content of approximately 15,000 mg/kg) and dilute nitric acid bleachers (approximately 32% w/w with nitrous acid content of approximately 7,000 mg/kg) producing less than 100 mg/kg residual nitrous acid. The extent of the chemical reactions and mass transfer resistances are dependent on, amongst other things:
The bleacher volume. In this discussion a production-specific volume of Hbl=0.1 h is considered. (“Production-specific volume” is defined here as the voidage volume of the packing divided by the volumetric flow rate of the nitric acid process product (stream 55 in FIG. 1), and is hereinafter referred to as the volume of the bleacher, with the dimension of time.)
Tower packing surface area density. In this discussion a structured packing with a surface density of 760 m²/m³ is considered, which is towards the upper limit of industrial practicality. As a result the calculated mass transfer resistances are at the lower end of industrial practicality, and the extent of chemical reaction (discussed below) is at the upper end.

Under the above conditions, the inventors have found that in concentrated nitric acid bleachers 80% or more of the nitrous acid is destroyed by the reactions in Eqn. 1 and Eqn. 2, with the greater destruction occurring in the liquid phase. The reaction of Eqn. 3 is also active in the liquid phase. Typically, approximately only 5% of the nitrous acid in the raw nitric acid needs to be removed, unreacted, in the gas effluent. Thus in the presence of chemical reaction the Vmin for concentrated nitric acid bleachers is typically approximately 5% of that shown in FIG. 3a.

On the other hand, the inventors have found that that the reactions of Eqns. 1 and 2 account for very much less nitrous acid destruction in dilute nitric acid bleachers. The lower nitric component concentrations in dilute nitric acid inhibit the reactions of Eqns. 1 and 2 relative to concentrated nitric acid, and the disproportionation of Eqn. 3 is relatively more significant. The extent of nitrous acid removal by reaction is highly temperature sensitive: at 30° C. approximately 80% of the nitrous acid must be removed as unreacted nitrous acid carried in the gas effluent, whereas at 80° C. approximately 15% must be so removed, due to higher reaction rates at higher temperatures.

FIG. 3b shows the reduced Vmin according to the adjustments in the preceding paragraphs which allow for the effects of chemical reaction over the temperature range indicated and on the calculation basis noted above. This curve may be approximately represented by the relationship:

$$V min = 2.4 \times {10}^{10} \cdot {e}^{\frac{8730}{{T}_{b}}} \qquad Eqn . 4$$

where T_{b} is the average absolute temperature in degrees Kelvin of the liquid within the bleacher. The average temperature is the arithmetic average of the inlet and outlet liquid temperatures where the equipment is adiabatic. Where the equipment is not adiabatic, intermediate liquid temperatures prior to and following the application of heating or cooling are also included in the average.

For example, at a temperature of 40° C. Vmin is approximately 300, and at 70° C. it is approximately 30.

By inspection of FIG. 3b, the adjusted Vmin for dilute nitric acid bleachers is four to ten times that for concentrated nitric acid bleachers, for a given operating temperature. Thus, at any given temperature the volumetric flow ratio (V) required in the dilute nitric acid bleachers is very much larger than might be expected on the basis of experience with concentrated acid bleachers.

In both dilute and concentrated nitric acid bleachers there is a maximum available volume ratio (Vmax):
In the dilute nitric acid process described herein, the Vmax arises when 100% of the oxidising gas feed 12 passes through the bleacher 52, and is inversely proportional to the absolute pressure and to the ratio of acid flow through the bleacher 52 in stream 37 to the nitric acid product flow 55 (R). R varies according to the extent of recycle to the scrubber 32 in stream 56 (discussed below), and is typically 1.5. Substantially all of the raw nitric acid stream 37 must flow through the bleacher 52, in order to avoid significant short-circuiting of nitrous acid rich raw nitric acid to the product nitric acid. The oxidising gas feed has an essentially fixed molar flow, to provide a small excess of oxygen (typically 1% to 5%) for complete oxidation of ammonia to nitric components. Consequently, for example, when bleacher 52 operates at 2 bara and 55° C. it has Vmax of approximately 170.
In conventional concentrated nitric acid plants only secondary air (which is not required in the combustor, but which is required in the absorber) is used for bleaching. The maximum allowable secondary air flow is primarily fixed by the ammonia concentration in the combustor feed which is required to avoid an explosive mix and to provide the required combustor temperature. The ammonia concentration may range from 13% in low pressure combustors to 10% in high pressure combustors. Typically about 3% oxygen is required at the top of the absorption tower to maintain adequate oxidation rates.

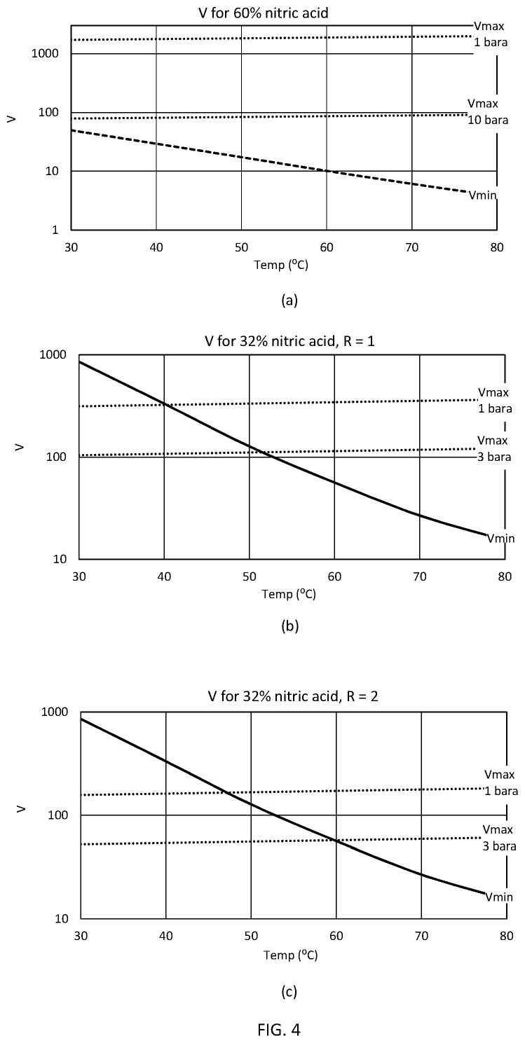

FIG. 4 charts Vmax together with Vmin for both concentrated and dilute nitric acid bleachers, and for ranges of pressures applicable to each. In the case of dilute nitric acid, charts for R=1 (no recycle of acid to the scrubber 32) and R=2 are presented.

Comparing FIG. 4a and FIG. 4b, it is evident that for concentrated nitric acid bleachers Vmax is always greater than Vmin for the range of temperatures and pressures considered. Thus under typical concentrated bleacher operating conditions Vmax does not constrain the selection of a V close to Vmin, and no incentive arises to use anything other than the available secondary air for bleaching.

For dilute nitric acid plant bleachers, however, FIG. 4b and FIG. 4c show that the selection of V is constrained by Vmax at lower temperatures, in contrast to the situation with concentrated nitric acid bleachers. For example, as may be interpolated from FIG. 4b and FIG. 4c, in a dilute nitric acid bleacher operating at 2 bara and 40° C., Vmin is approximately 300, and Vmax for R=1.5 is approximately 100. Therefore, under these conditions, the dilute nitric acid bleacher cannot achieve nitrous acid residue ≤100 mg/kg, because the minimum required V is greater than the maximum available V. The temperature must increase to 55° C. or more for Vmin to fall significantly below Vmax.

Vmax for the dilute acid charts in FIG. 4 may be approximated by:

$$V max = 1.036 \frac{{T}_{f}}{PR} B \qquad Eqn . 5$$

where B is the fraction of the oxidiser feed 12 passing to the bleacher 52 in stream 12a, T_{f} is the absolute temperature of the oxidising gas feed 12a, P is the absorber pressure in bara and R is the ratio of acid flow through the bleacher 52 in stream 37 to the nitric acid product flow 55.

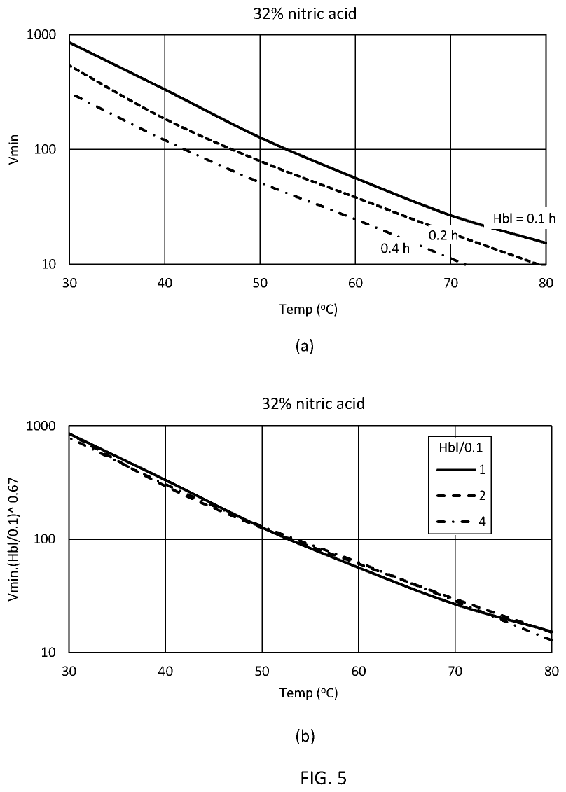

Vmin can be modified by increasing the bleacher volume relative to the value of 0.1 h considered above. FIG. 5a illustrates the effect of increasing the bleacher volume on Vmin, while FIG. 5b illustrates that the effect on Vmin can be quantified as a factor of approximately (Hbl/0.1)^{0.67} where Hbl is the bleacher volume (in h). Thus Eqn. 4 can be generalised to Eqn. 6:

$$V min = 2.4 \times {10}^{- 10} {{e}^{\frac{8730}{{T}_{b}}} ( \frac{Hbl}{0.1} )}^{- 0.67}$$

Eqns. 5 and 6 define the approximate upper and lower bounds for V in a dilute acid bleacher in order to achieve residual nitrous acid ≤100 mg/kg. Where Vmin exceeds Vmax there is no feasible V, even with high surface density structured packing.

For example, in the case of a 2 bara bleacher operating at 45° C., oxidiser gas feed at 100° C., 100% of the oxidiser feed passing to the bleacher, R=1.5 and 0.1 h volume, Vmax is approximately 130 and Vmin approximately 200. 100 mg/kg residual nitrous acid is infeasible under these conditions. At a bleacher temperature of 55° C., however, Vmin decreases to about 90 and successful operation is feasible. Were only 50% of the oxidising gas feed directed to the bleacher 52, a bleacher temperature of at least 60° C. would be required to bring Vmin below Vmax.

The use of an oxygen-rich oxidising gas in a dilute nitric acid process permits substantial reductions in the absorber size required for the plant relative to that required with air as the oxidising gas, as inert nitrogen diluent inherent with air interferes with the gas phase reactions and mass transfer in the absorber, requiring large volumes for adequate absorption. Such a dilute nitric acid process is therefore especially suited to enabling the assembly of a compact nitric acid plant. In such a plant, auxiliary equipment, such as the bleacher, is typically proportionate in size to the compact absorber. In an embodiment, the compact absorber is typically 0.2 hr in volume (considering the total volume of absorber divided by the nitric acid process volumetric production rate), and thus for the bleacher to be reasonably proportionate in size to the absorber its volume is typically less than 0.4 h, more typically less than 0.2 h and most typically less than 0.1 h.

Since approximately 63% of the oxidiser gas feed 12 is required by the combustor 15 for the complete oxidation of ammonia 10 to nitrogen monoxide, a substantial fraction of the oxidising gas feed passing through the bleacher (12a, 12c) must be directed to the combustor feed 13 when 12a is a high proportion of 12. Slippage of unoxidised ammonia through the combustor may give rise to the formation of explosive ammonium salts within the equipment downstream of the combustor. Therefore, in an embodiment at least 70% of the oxidising gas feed 12 is directed to the combustor 15, either after having passed through the bleacher 52 (as shown by the continuous line in FIG. 1, stream 12c) or directly (as shown by the dashed line in FIG. 1, stream 12e), or by some combination of the two.

That portion of the oxidising gas feed 12 which does not pass to the combustor 15 as described above (stream 120 may be injected into the nitrous gas stream 16 as stream 12h and/or into the cooled nitrous gas stream 18 as stream 12g, as indicated by dashed feed lines in FIG. 1. Such bypassing of a minor proportion of the oxidising gas feed around the combustor allows control of the combustor temperature by reducing the ballast in the combustor feed 13. For example, bypassing approximately 30% of the oxidising gas feed around the combustor 15 in stream 12f increases the combustor temperature by about 40° C.

Depending on the relative flows in 12a, 12c and 12f, the flow in 12e may be towards the combustor 15 or it may bypass the combustor.

TABLE 2 lists the minimum fraction (E) of the bleacher gas effluent which must pass to the combustor 15 for various fractions (B) of the oxidising gas feed passing to the bleacher 52 and various fractions (C) of the oxidising gas feed bypassing both the bleacher 52 and the combustor 15, in order to provide a minimum of 70% of the oxidising gas feed 12d to the combustor 15. Where more than one-third of the oxidising gas feed passes to the bleacher 52, no less than one-tenth of the bleacher effluent 12c must pass to the combustor 15 for 70% of the oxidising gas feed to reach the combustor.

TABLE 2
Minimum fraction of bleacher effluent to combustor

| | Minimum fraction of bleacher effluent to combustor | | |
|---|---|---|---|
| | E for minimum 70% of oxidiser feed to combustor | | |
| | E =1 − (C − 0.3)/B where B + C <= 1 | | |
| | C = 0.00 | 0.15 | 0.30 |
| B = 1.00 | 0.70 | | |
| 0.90 | 0.67 | | |
| 0.80 | 0.63 | 0.81 | |
| 0.50 | 0.40 | 0.70 | 1.00 |
| 0.333... | 0.10 | 0.55 | 1.00 |

From the discussion above, it is apparent that the oxidising gas effluent 12c from the bleacher vessel 50 carries with it various components from the raw nitric acid 37, including the nitrous components and water. The nitrous components in stream 12c predominantly remain available within the process to ultimately produce nitric acid product in 55, since they are available for further oxidation in the absorber 19:
The nitrous components carried with the oxidising gas 12d which proceeds to the combustor 15 decompose to NO in the vicinity of the hot gauze within the combustor before passing to the nitrous gas stream 16 and, ultimately, the absorber feed 24.
The nitrous components carried with the oxidising gas which bypasses the combustor 15 in stream 12f are mixed with the nitrous gas stream 16 or 18 to form the absorber feed 24. In the absorber, approximately 95% of the nitrous components in absorber feed 24 are typically oxidised to HNO₃. Therefore, the recycle of the residual nitrous components in the absorber effluent 23 necessarily gives rise to only a 5% increment in the flow of nitrous components entering the equipment downstream of the absorber, including the scrubber 32 and the bleacher 52.

Such recycle improves the overall process conversion efficiency by about 5%, as nitrous components may be recycled essentially to extinction, with only very low levels of nitrous discharge in the nitric acid product 55 and in the tail gas 43 (as discussed below).

Typically, nitrous acid accumulation in the process is avoided because of its potential to form unstable nitrites—for example, on mixing of the ammonia feed 10 with the oxidising gas recycle 12d. The inventors have found that the high degree of oxidation achieved in the absorber 19, as discussed above, applies to the nitrous acid constituent of the nitrous recycle components in addition to constituents such as NO and NO₂, with the result that nitrous acid accumulation is inherently strongly suppressed.

A further safeguard against nitrous acid accumulation is provided by recycling a substantial proportion of the oxidising gases 12c to the combustor 15 in stream 12d, so that the nitrous acid recycle constituent is wholly thermally decomposed to yield NO. This consideration is consistent with the statements above concerning a high proportion of the oxidising gas feed being passed to the combustor 15 (typically at least 70%), and a high proportion of the oxidising gas feed passing through the bleacher 52 (typically exceeding 50%, more typically exceeding 90%, and most typically exceeding 98%).

Scrubber

Gases not condensed or absorbed in the absorber 19 are separated from the liquid phase, to form an absorber gas effluent 40, by a separator 31 that is depicted as part of the scrubber vessel 30. The principal components of the absorber gas effluent 40 are excess unreacted oxygen, argon and other impurities introduced with the oxidising gas feed to the process, nitrogen and nitrous oxide formed as by-products in the combustor, and water vapour. The absorber gas effluent also contains nitrous components whose total concentration within the absorber gas effluent may exceed 1 mol % on a dry basis, and may approach, and sometimes exceed, 10 mol % (dry).

The absorber gas effluent 40 may be fed from the separator 31 to the scrubber 32 for counter-current contact with a suitable scrubbing liquid, such as water or bleached acid. The scrubber vessel 30 may take the form of a packed tower, for example employing random or structured packing, or may employ stage-wise contacting in trays, such as sieve trays or valve trays. The scrubber vessel 30 may also incorporate cooling to avoid undue temperature rise during the physical absorption and chemical reaction processes.

Gas scrubbing with water or bleached acid cannot achieve nitrous component levels in the tail gas which are compatible with discharge to atmosphere. The aim of scrubbing is therefore to substantially reduce nitrous levels, in equipment of reasonable size and cost, in preparation for “polishing” to discharge levels. Thus there is a trade-off between scrubbing and polishing costs. The option of polishing with ozone is discussed below.

When water is employed for the scrubbing, it may be chilled to aid absorption. At a sufficiently low water flow rates, the liquid effluent from the scrubber may exceed 30% w/w nitric acid, closely matching the product concentration, though cooling of the scrubber would be required to avoid an excessive temperature rise.

As illustrated in FIG. 1, the absorber gas effluent 40 may alternatively be scrubbed with a stream of bleached acid 56 from the bleacher 52. The use of bleached acid for scrubbing results in a slightly higher nitric acid product concentration and avoids the need for sourcing a water feed. However, as discussed above, the recycle of bleached acid to the scrubber reduces Vmax for the bleacher and therefore tends to require higher minimum bleacher operating temperatures and/or larger minimum bleacher volumes.

The bleached acid 56 may optionally be cooled in cooler 57 to aid absorption. The cooling load of the cooler may be reduced through the use of feed-effluent heat exchange (not shown in FIG. 1) with the scrubber effluent 37, with such feed-effluent exchange also reducing the heating load on heater 39. Typically, however, the scrubber and the bleacher operate at similar temperatures, removing the need for the cooler and the heater (and a feed-effluent exchanger) and thereby providing for a simpler process. Where the flow of bleached acid to the scrubber is sufficiently high the small temperature rise in an adiabatic scrubber does not materially affect the scrubber performance.

The bleached acid flow in stream 56 to the scrubber 32 should be greater than 20% of the nitric acid product flow in stream 55, in order to achieve a suitably substantial reduction of nitrous components in the absorber gas effluent 40 within a scrubber of reasonable volume. In an embodiment, the flow of stream 56 is greater than 25% of the flow of stream 55, and most typically it is greater than 40%.

In compact nitric acid plant, a proportionate size for a packed-tower scrubber is one in which the packing volume would sustain a volume of less than 0.4 h, typically less than 0.2 h and most typically less than 0.1 h. (The scrubber volume is normalised by taking the ratio of the volume to the nitric acid product flow 55, as for the bleacher.) In an embodiment, the scrubber gas effluent 41 from the scrubber 32 consists of less than 1 mol % (dry) nitrous components, and more typically less than 0.5 mol % (dry).

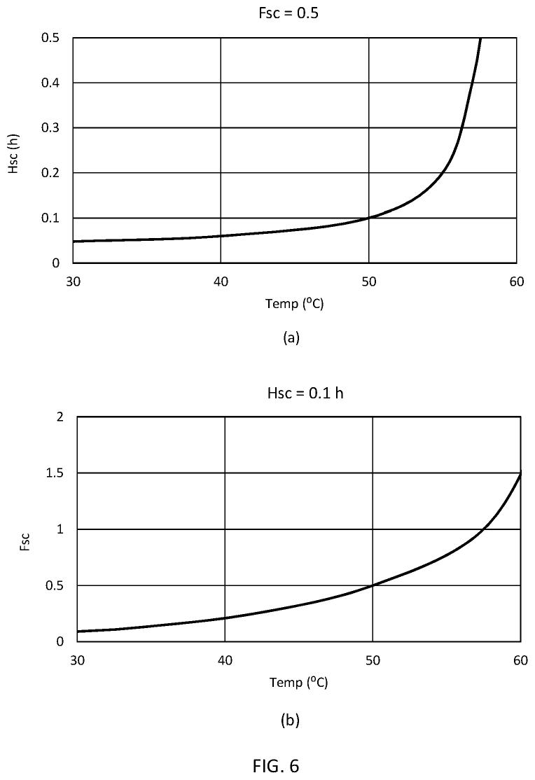

FIG. 6 shows the approximate temperature dependencies of:
a) the scrubber volume Hsc, for a fixed ratio (Fsc) of nitric acid recycle 56 to nitric acid product 55 of 50%
b) Fsc, for a fixed Hsc of 0.1 h.

As for the bleacher, a structured packing with surface area density of 760 m²/m³ is considered. A dry nitrous gas content of less than 0.5 dry mol % is required in the scrubber gas effluent 41.

It is evident from FIG. 6 that for temperatures above 50° C. there is a rapid increase in Hsc and Fsc required to achieve the required nitrous level. Increasing Hsc is notably disadvantageous for a compact plant. In addition, high Fsc is also disadvantageous as it increases R for the bleacher (R=1+Fsc), thus tending to increase its required size.

Bleacher and Scrubber Operating Together

It is evident from FIG. 1 that the bleacher and scrubber operate at similar pressures. Typically the pressure is greater than atmospheric pressure in order to assist plant compactness, but less than 3 bara in order to enable the use of an oxidising gas feed at relatively low pressure. Typically the common operating pressure is approximately 2 bara, typically between 1.5 bara and 2.5 bara. In principle, lower operating pressures would increase the V available to the bleacher at a given B, but near-atmospheric pressure operation would tend to increase the size of piping and vessels.

As discussed previously, it is also typical, for plant and process simplicity, that the scrubber 32 and bleacher 52 operate at similar temperatures in order to avoid heating and cooling of the liquid feed streams by means of heater 39 and cooler 57, and any supplementary feed-effluent heat exchange. Higher temperatures tend to minimise the required bleacher volume, but also tend to increase the required scrubber volume, creating the need for a trade-off in the selected temperature to maintain plant compactness.

Also as discussed previously, Fsc, which governs the liquid feed rate to the scrubber, is related to R, which governs the liquid feed rate to the bleacher, by R=1+Fsc. Higher Fsc tends to minimise the required scrubber volume, but also tends to increase the bleacher volume, creating the need for another trade-off to maintain plant compactness.

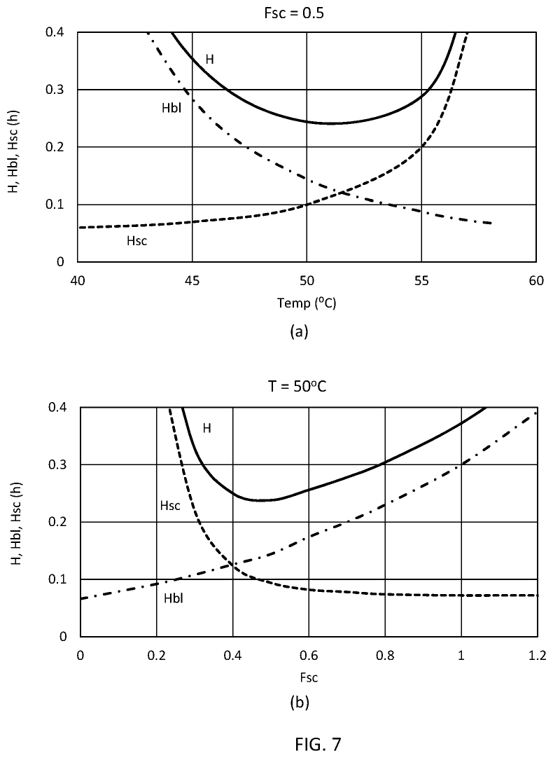

FIG. 7 charts the combined volume H (=Hbl+Hsc) of the bleacher and scrubber as a function of (a) temperature, at Fsc of 50%, and (b) Fsc, at fixed temperature of 50° C. The required effluent concentrations are, for the bleacher liquid effluent, nitrous acid ≤100 mg/kg nitrous acid, and, for the scrubber gas effluent, nitrous components ≤0.5 mol % (dry basis). The pressure is approximately 2 bara. Clearly there is a relatively narrow range of operating conditions which maintain overall plant compactness:
Temperature in the range 43° C. to 57° C., and typically in the range 47° C. to 55° C. Beyond the lower end of the temperature ranges the bleacher volume becomes increasingly disproportionate, and beyond the upper end the scrubber volume becomes increasingly disproportionate.
Fsc in the range 25% to 100%, and typically in the range 30% to 80%. Beyond the lower end of the Fsc ranges the scrubber volume becomes increasingly disproportionate, and beyond the upper end the bleacher volume becomes increasingly disproportionate.

Ozonator

Whilst the scrubber 32 is capable of achieving approximately one order-of-magnitude reduction in nitrous components in the absorber gas effluent 40, as disclosed above, the scrubber gas effluent 41 from the scrubber still carries with it excessive nitrous components to permit it to be discharged to atmosphere.

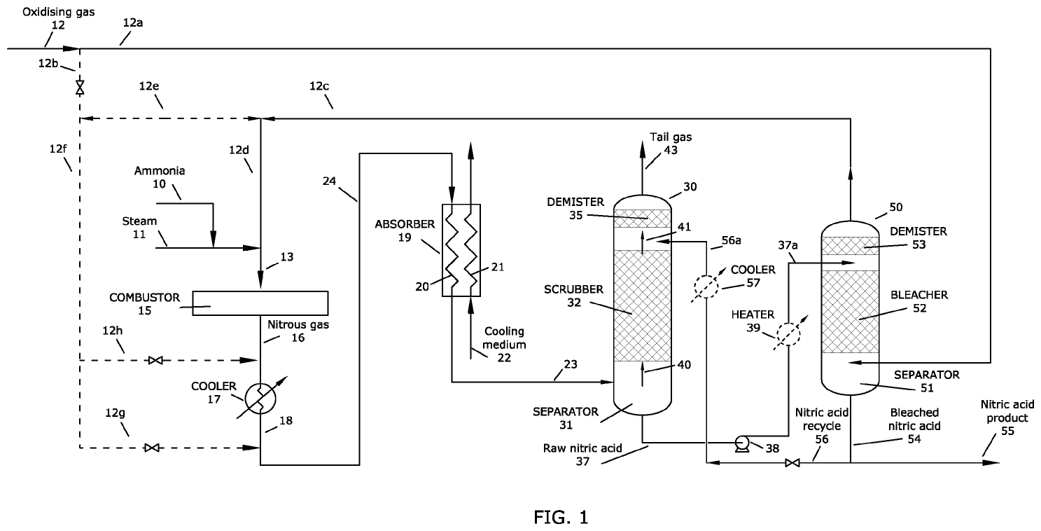

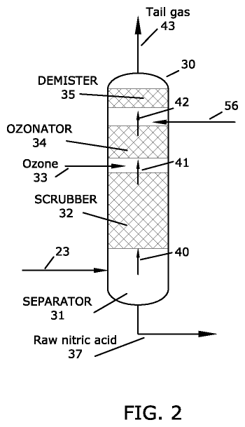

FIG. 2 illustrates how a strong gaseous oxidant, such as ozone, may be injected into a top section of the scrubber vessel 30 in an ozone-containing stream 33, to create an ozonator 34, in order to oxidise most nitrous components to oxidation state+5—nitric acid (HNO₃). Alternatively, hydrogen peroxide may be used as the oxidant. The ozone-containing stream 33 may derive from a split from the oxidising gas feed 12, passing through an ozone generator, and contains both oxygen and ozone, in approximate proportions O₂:O₃=10:1. Nitric acid formed in the ozonator is dissolved in the bleached nitric acid scrubbing stream 56, and thus ultimately becomes part of the nitric acid product stream 55. Residual ozone in the ozonator gas effluent 42 may be decomposed by contact with an ozone decomposition catalyst, such as manganese oxide, housed in or adjacent to the demister 35 at the top of the scrubber vessel 30.

Where the scrubber gas effluent 41 has a nitrous component level ≤1 mol % (dry), the ozone-containing stream 33 requires a split of ≤2% of the oxidising gas 12 molar feed rate. The nitrous component molar flow in the scrubber gas effluent corresponds to ≤0.24% of the nitric component molar flow in the nitric acid product stream 55, requiring a molar flow of O₃≤0.4% of the nitric component molar flow in the nitric acid product stream 55.

Typically, the scrubber gas effluent 41 has a nitrous component level ≤0.5 mol % (dry), so that the ozone-containing stream 33 requires a split of ≤1% of the oxidising gas 12 molar feed rate. The nitrous component molar flow in the scrubber gas effluent corresponds to ≤0.12% of the nitric component molar flow in the nitric acid product stream 55, requiring a molar flow of O₃≤0.2% of the nitric component molar flow in the nitric acid product stream 55. Such ozonation therefore gives rise to a very small increment in operating cost, while also enhancing the yield of nitric acid from the process.

The essentially complete oxidation of nitrous components to nitric components so achieved obviates the need for further nitrous component removal from the gas by conventional means such as selective catalytic reduction (SCR), thereby eliminating an expensive SCR reactor and the need to consume ammonia as the SCR reductant.

The use of ozone as described for the dilute acid process of FIG. 1 and FIG. 2 is especially attractive relative to its potential use in conventional concentrated nitric acid plants because:
a. ozone may be efficiently produced from a stream containing a high concentration of O₂ (oxidising gas feed 12);
b. the nitrous gas component flow in the scrubber gas effluent 41 is a very small fraction of the nitric acid component flow in in stream 55, and therefore requires a correspondingly small flow of valuable ozone to bring about its complete oxidation to nitric components; and
c. the low concentration of inert nitrogen diluent in the oxidising gas leads to a small volumetric flow of scrubber gas effluent 41, thereby enabling the mixing and reaction of the gas effluent and the ozone stream 33 in a proportionately compact volume.

Alternatively or additionally, an aqueous oxidant such as hydrogen peroxide solution may be injected into the top section of the scrubber 32 or ozonator 34 in conjunction with the injection of bleached acid 56. Nitric acid formed from the oxidation of the nitrous components to oxidation state 5 is dissolved in the bleached nitric acid scrubbing stream 56, and thus ultimately becomes part of the nitric acid product stream 55. Residual hydrogen peroxide may be decomposed by contact with an appropriate catalyst such as platinum housed in or at the base of the scrubber 32.

The tail gas effluent 43 from the demister is likely to contain small quantities of N₂O contaminant requiring removal prior to discharge to the atmosphere, the nitrous components, including those commonly referred to as NOx, having been effectively eliminated by the scrubber 32 and ozonator 34.

Thus, in addition, to bleaching of the nitric acid, the process as disclosed herein gives rise to very low levels of nitrous components in the nitric acid product, and to negligible gaseous emissions of NOx.

Whilst a number of specific process embodiments have been described, it should be appreciated that the process may be embodied in other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the process as disclosed herein.

1. A process for removing nitrous components from a raw liquid nitric acid stream to produce a bleached nitric acid product, the raw liquid nitric acid stream being from an absorber of a nitric acid process, the process comprising contacting the raw nitric acid liquid stream with an oxidising gas in a bleaching stage, wherein at least some of the gas effluent from the bleaching stage enters a combustion stage of the nitric acid process.

2. A process as claimed in claim 1 wherein the oxidising gas entering the bleaching stage comprises at least about one-third of an oxidising gas feed to the nitric acid process, and wherein at least about one-tenth of the bleaching stage gas effluent enters the combustion stage.

3. A process as claimed in claim 1 wherein at least 90% of the oxidising gas feed to the nitric acid process enters the bleaching stage and at least 65% of the bleaching stage gas effluent enters the combustion stage.

4. A process as claimed in claim 1, wherein the fraction of the bleaching stage gas effluent which enters the combustion stage is at least:
$$1 - \frac{c - 0.3}{B} , B + C \leq 1$$
where B is the fraction of the oxidising gas feed to the nitric acid process which enters the bleaching stage, and C is a fraction of the oxidising gas feed which bypasses both the bleaching and combustion stages.

5. A process as claimed in claim 1, wherein a ratio of the volumetric feed rate of oxidising gas to the bleaching stage to the volumetric flow rate of raw nitric acid to the bleaching stage is no less than:
$$2.4 \times {10}^{- 10} \cdot {e}^{\frac{8730}{{T}_{b}}}$$
where T_{b} is the average absolute temperature in degrees Kelvin of liquid within the bleaching stage.

6. A process as claimed in claim 1, wherein a ratio of the volumetric feed rate of oxidising gas to the bleaching stage to the volumetric flow rate of raw nitric acid to the bleaching stage is no less than:
$$2.4 \times {10}^{- 10} \cdot {{e}^{\frac{8730}{{T}_{b}}} ( \frac{Hbl}{0.1} )}^{- 0.67}$$
where T_{b} is the average absolute temperature in degrees Kelvin of liquid within the bleaching stage, and where Hbl is the ratio of the bleacher volume to the volumetric flow rate of nitric acid product produced by the process.

7. A process as claimed in claim 1, further comprising a scrubbing stage in which bleached nitric acid from the bleaching stage is contacted with gas phase effluent from the absorber.

8. A process as claimed in claim 7 wherein the flow of the bleached nitric acid from the bleaching stage to the scrubbing stage is at least about 25% of nitric acid product produced by the process.

9. A process as claimed in claim 7 wherein the temperature of liquid feeds to the bleaching and scrubbing stages is approximately 50° C. (±7° C.) and the flow of bleached nitric acid to the scrubbing stage is approximately 50% (+50%, −25%), of nitric acid product produced by the process.

10. A process as claimed in claim 7 wherein the temperature of liquid feeds to the bleaching and scrubbing stages is approximately 51° C. (±4° C.) and the flow of bleached nitric acid to the scrubbing stage is approximately 50% (+30%, −20%), of nitric acid product produced by the process.

11. A process as claimed in claim 7, wherein the scrubbing stage further comprises oxidising substantially all the nitrous components in a gas phase effluent of the scrubbing stage to a nitrogen oxidation state of +5.

12. A process as claimed in claim 11 wherein the nitrous components in the scrubbing stage gas phase effluent are oxidised with a strong oxidant.

13. A process as claimed in claim 12 wherein the strong oxidant is ozone, and the molar flow rate of ozone is ≤0.4% of the molar flow rate of a nitric component in the bleached nitric acid produced by the bleaching stage.

14. A process as claimed in claim 13 wherein the molar flow rate of ozone is ≤0.2% of the molar flow rate of a nitric component in the bleached nitric acid produced by the bleaching stage.

15. A process as claimed in claim 12 wherein the strong oxidant is ozone, and the ozone is a component in an oxygen-rich stream comprising ≤2% of the molar flow rate of the oxidising gas feed to the nitric acid process.

16. A process as claimed in claim 15 wherein the ozone is a component in an oxygen-rich stream comprising ≤1% of the molar flow rate of the oxidising gas feed to the nitric acid process.

17. A process as claimed in claim 1, wherein the nitric acid produced by the nitric acid process comprises dilute nitric acid.

18. A process as claimed in claim 17 wherein the dilute nitric acid has a concentration of approximately 20% to 40% HNO3 (w/w).

19. A process as claimed in claim 1, wherein the oxidising gas comprises more than about 80% (v/v) oxygen.

20. The process as claimed in claim 12, wherein the strong oxidant comprises ozone or hydrogen peroxide.
